(19) United States
(12) Patent Application Publication
(10) Pub. No.: US 2013/0250543 A1
(43) Pub. Date: Sep. 26, 2013

(54) LIGHTING DEVICE

(71) Applicants: JIH-SHENG HUANG, TAOYUAN COUNTY (TW); CHAO-KUN CHAN, TAOYUAN COUNTY (TW); CHI-FU CHUANG, NEW TAIPEI CITY (TW)

(72) Inventors: JIH-SHENG HUANG, TAOYUAN COUNTY (TW); CHAO-KUN CHAN, TAOYUAN COUNTY (TW); CHI-FU CHUANG, NEW TAIPEI CITY (TW)

(73) Assignee: ENLIGHT CORPORATION, TAOYUAN COUNTY (TW)

(21) Appl. No.: 13/535,385

(22) Filed: Jun. 28, 2012

(30) Foreign Application Priority Data
Mar. 23, 2012 (TW) 101110073

(51) Int. Cl. F21V 9/14

(52) U.S. Cl. 362/19

(57) ABSTRACT

The instant disclosure relates to a lighting device, which includes a lighting module, a reflector, a light-guiding member, a main body, and a cover. The lighting module includes a base plate and a plurality of light-emitting units mounted on the base plate. The reflector has at least one reflective surface proximate to the base plate. The cross-section of the reflector gradually decreases in a direction toward the base. The light-guiding member is disposed between the lighting module and the reflector. The light-guiding member has a polarizing portion for reflecting light emitted from the light-emitting units. The base plate is disposed on one end of the main body. The cover is selectively disposed on the main body. Thus, an omni-directional lighting device is presented.

### BACKGROUND OF THE INVENTION

1. Field of the Invention

The instant disclosure relates to a lighting device; in particular, to a lighting device using light emitting diodes as the light source.

2. Description of Related Art

With continuous innovation in technology, people's lifestyle changes significantly. The standard of living is expected to advance. These innovative products serve as an indicator of modern evolution.

The concepts of energy saving and recycling have gained much attention in today's society. On the other hand, electrical appliances are been used widely today. The mass usage means a higher replacement rate as compare to other commodities. One example is lighting devices. For existing lighting devices such as fluorescent lamps, incandescent bulbs, and energy-saving bulbs, some common disadvantages include rapid light decay, high power consumption, large heat dissipation, short life time, etc. To address these issues, light-emitting diode (LED)-based lighting devices have been gradually adopted by the public.

There is a wide range of energy saving bulbs sold in the market, such as screw-type, U-shaped, tube-shaped, spherical shaped, etc. The design basis of today's lighting devices includes illumination angle and light intensity. Therefore, the provision of an effective lighting device while being environmental friendly is the main focus of the industry.

To address the above issues, the inventors strive via industrial experience and academic research to present the instant disclosure, which can effectively improve the limitations described above.

### SUMMARY OF THE INVENTION

The object of the instant disclosure is to provide a lighting device, particularly to a lighting device having a reflector and a light-guiding member to increase the illumination range.

In order to achieve the aforementioned object, according to an embodiment of the instant disclosure, the lighting device comprises a lighting module, a reflector, a light-guiding member, and a main body. The lighting module includes a base plate supporting a plurality of light-emitting units. The reflector has at least one reflective surface proximate to the base plate. The cross-section of the reflector gradually tapers in a direction toward the base plate. The light-guiding member is disposed between the lighting module and the reflector. The light-guiding member has a polarizing portion for reflecting incident light emitted from the light-emitting units. The main body supports the base plate.

Preferably, the lighting device further comprises a cover selectively mounted on the main body. The cover defines a receiving space to accommodate the lighting module, the reflector, and the light-guiding member.

Preferably, the reflector is substantially cone-shaped and non-light permitting.

Preferably, the reflective surface of the light guiding member is arch-shaped. The reflective surface reflects incident light emitting from the light-emitting units.

Preferably, the light-guiding member is substantially annular shaped and light-permitting. The light-emitting units are disposed on the base plate and under the light-guiding member.

Preferably, the polarizing portion has a smooth surface texture and is substantially arch-shaped. The polarizing portion reflects incident light emitted from the light-emitting units. The inner diameter of the polarizing portion gradually reduces in a direction away from the base plate.

Preferably, the reflector is substantially pyramid-shaped. The light-emitting units emit light in a direction toward the reflective surfaces.

Preferably, the reflective surface is substantially a flat surface, a parabolic surface, a free-form surface, or a polysurface.

Preferably, the main body has a heat-dissipating portion and a mounting portion connected therewith. The lighting module is disposed on the main body.

Preferably, the base plate includes a circuit board. The light-emitting units are light-emitting diodes (LEDs) connected electrically to the circuit board.

Based on the above, the instant disclosure has the following advantages:

The lighting device of the instant disclosure utilizes the reflector and the light-guiding member, particularly with the polarizing portion of the light-guiding member, to provide wider illumination angle than traditional incandescent bulbs and LEDs. Thus, a better illumination quality is achieved.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows an exploded view of a lighting device according to the instant disclosure.

FIG. 2 shows another exploded view of the lighting device according to the instant disclosure.

FIG. 3 shows a perspective view of the lighting device according to the instant disclosure.

FIG. 4 is a schematic view showing the light traveling path for the lighting device of the instant disclosure.

FIG. 5 shows a perspective view of the cover and the lighting device according to the instant disclosure.

FIG. 6 shows a perspective view of the cover mounted on the lighting device according to the instant disclosure.

FIG. 7 is a schematic view showing the light traveling paths for the lighting device of the instant disclosure.

FIGS. 8A-8B and 8C show plan views of various types of reflector according to the instant disclosure.

### DETAILED DESCRIPTION OF THE PREFERRED EMBODIMENTS

Unless specifically stated otherwise, the number of parts for the embodiments as will hereinafter be described is not restricted.

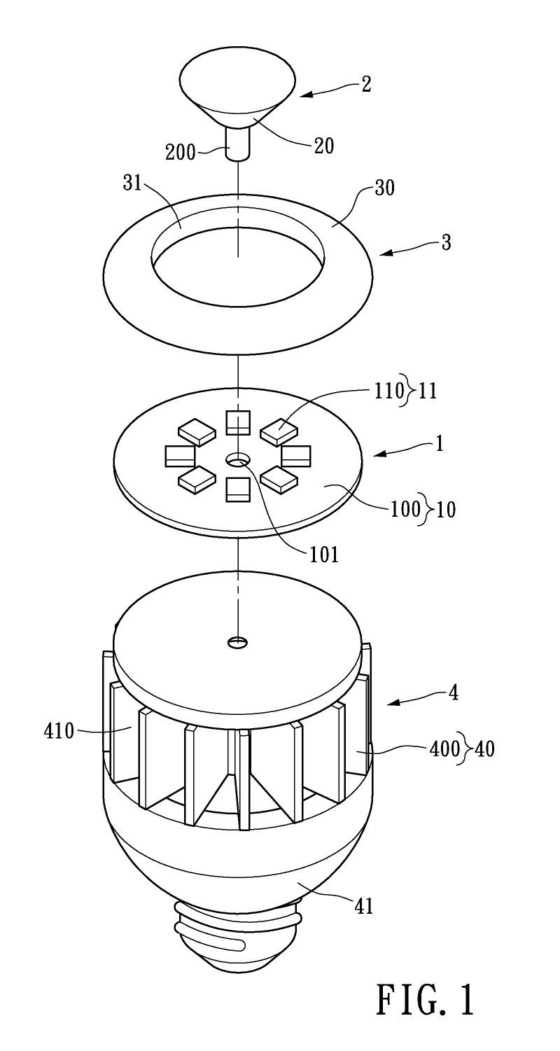

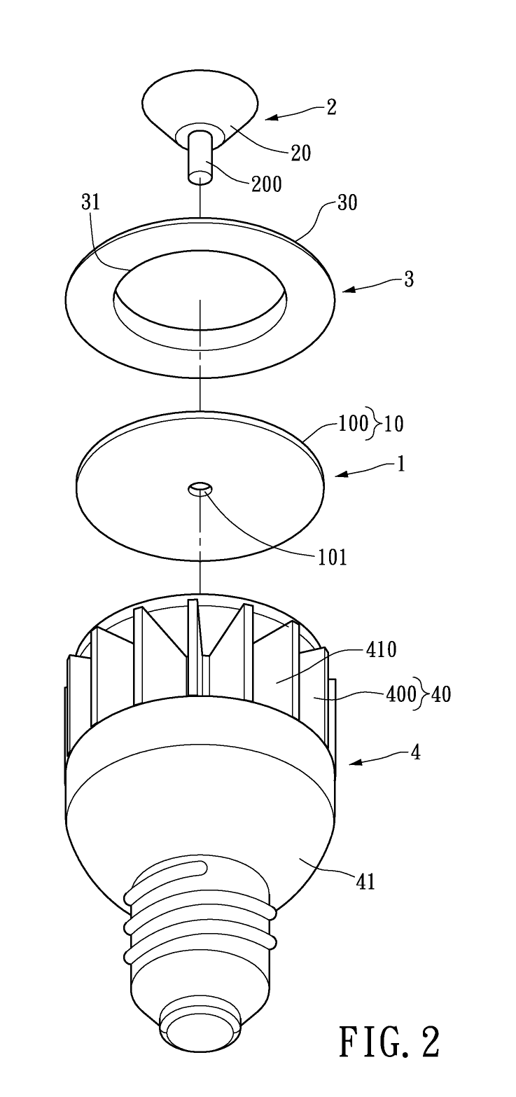

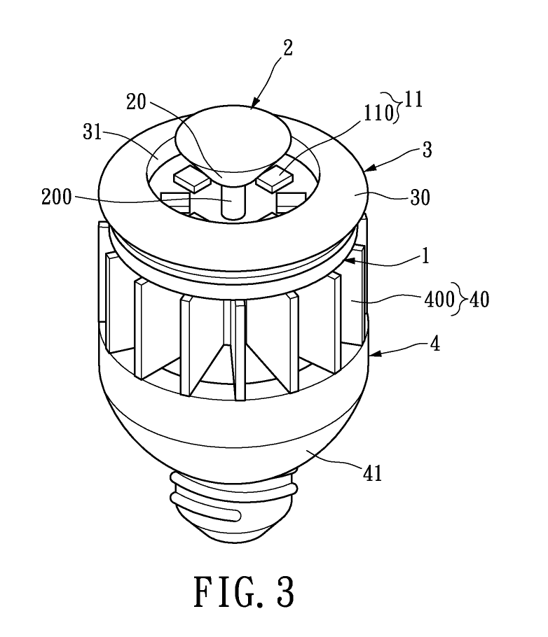

Please refer to FIGS. 1, 2, and 3. FIG. 1 illustrates an exploded view of a lighting device of the instant disclosure. FIG. 2 is another exploded view of the lighting device of the instant disclosure. Whereas FIG. 3 illustrates a perspective view of the lighting device of the instant disclosure.

The lighting device of the instant disclosure comprises a lighting module 1, a reflector 2, a light-guiding member 3, and a main body 4. The lighting module 1 includes a base plate 10 and a plurality of light-emitting units 11. The light-emitting units 11 are mounted on the base plate 10. The base plate 10 includes a circuit board 100 connected electrically to the light-emitting units 11. The light-emitting units 11 are light-emitting diodes (LEDs) 110, but are not restricted thereto. Other light sources may be used also. For the instant embodiment, there are eight LEDs 110. However, the number of LEDs 110 is not restricted.

Specifically, the LEDs 110 are arranged annularly on the base plate 10. The base plate 10 is substantially circular-shaped but not limited thereto. A through hole 101 is formed centrally on the base plate 10 for securing the reflector 2.

The reflector 2 is substantially funnel-shaped having a connecting portion 200. Specifically, the reflector 2 has two end surfaces and a side surface connected therebetween. The cross-section of the reflector 2 gradually decreases in a direction toward the base plate 10. Nevertheless, the type of the reflector 2 is not restricted thereto.

In other words, the areas of the two end surfaces are different from each other. The end surface with smaller surface area is arranged closer toward the base plate 10. The side wall of the reflector 2 is a reflective surface 20. The shape of the reflective surface 20 and the distance/angle between the reflective surface 20 and the base plate 10 are configured depending on specific operational requirement or practical needs and not be limited to the exemplary embodiment provided herein.

The connecting portion 200 of the reflector 2 is substantially rod-shaped. One end of the connecting portion 200 is inserted into the through hole 101 of the base plate 10 for positioning the reflector 2. However, the reflector 2 may be disposed by other means. For example, the reflector 2 may be connected to a cover 5 or disposed on the light-guiding member 3, but is not restricted thereto.

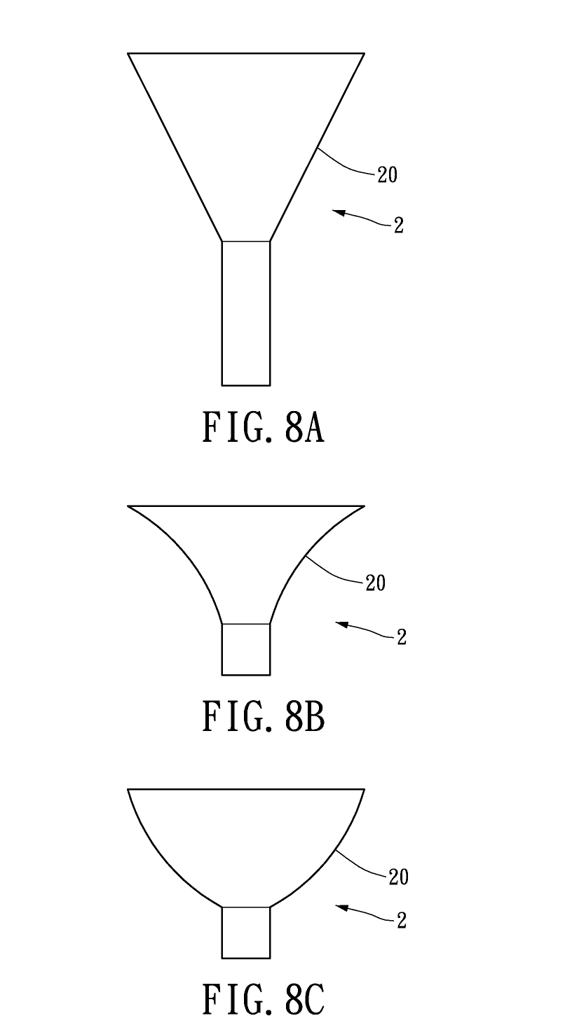

Please refer to FIGS. 8A, 8B, and 8C. All three figures illustrate plan views of different shaped reflectors 2 according to the instant disclosure. The reflector 2 is constructed of a non-light permitting material and may be cone- or pyramid-shaped (not shown). When the reflector 2 is a pyramid-like structure, the reflector 2 is multi-faced having multiple reflective surfaces 20. The reflective surfaces 20 are held facing the light emitting directions of the LEDs 110 to perform light reflection.

Furthermore, the reflective surface 20 can be a flat surface, a parabolic surface, a free-form surface, or a polysurface. For the instant embodiment, the reflective surface 20 is a flat surface, but is not restricted thereto.

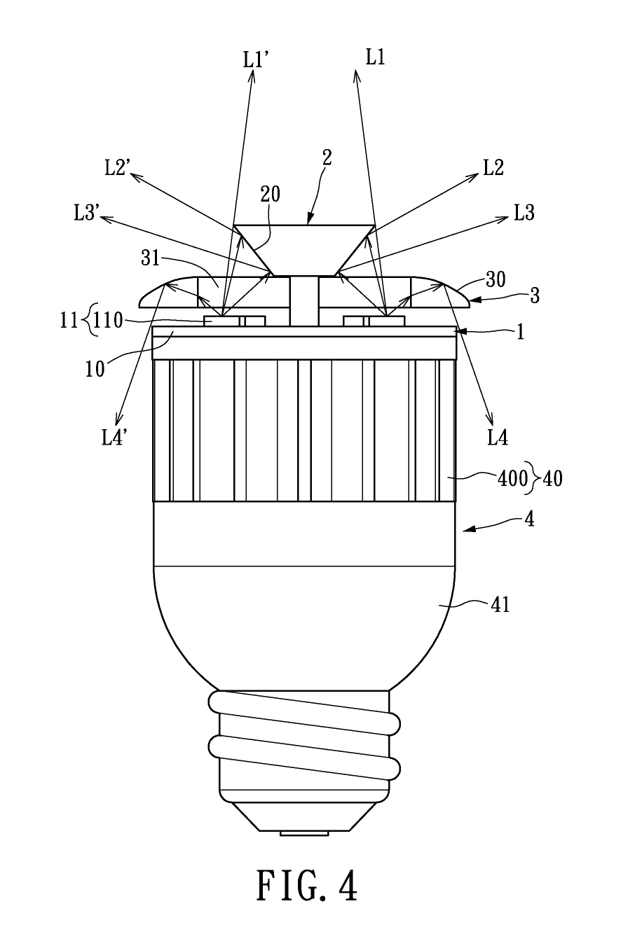

Please refer to FIG. 4, which shows the light traveling paths for the lighting device of the instant disclosure. Specifically, light rays L2 and L3 emitted from the light-emitting units 11 are reflected by the reflective surface 20. The illumination angle of one LED 110 is typically 120°. The lighting device of the instant disclosure utilizes the reflector 2 to provide a broader illumination range. Namely, in addition to a light ray L1 emitted from the light-emitting unit 110, the reflector 2 reflects the incident light rays L2 and L3 to expand the illumination angle.

Please refer to FIG. 4 again. The light-guiding member 3 is annular shaped and light-permitting. The light-guiding member 3 has a polarizing portion 30, which is arch-shaped and having a polished surface texture. The polarizing portion 30 reflects incident light rays L4 and L4′ emitted from the LEDs 110. The shape of the polarizing portion 30 is not restricted.

More specifically, one side of the light-guiding member 3 is substantially flat. The polarizing portion 30 is formed on another side of the light-guiding member 3. The light-guiding member 3 is formed with a circular opening 31. The opening 31 is formed along the light-emitting direction of the LEDs 110. In other words, the LEDs 110 are disposed within the area where the light-guiding member 3 orthographically project on one side of the base plate 10.

Please refer to FIG. 2, where the main body 4 has a heat dissipating portion 40 and a mounting portion 41. The mounting portion 41 is connected to one end of the heat-dissipating portion 40, and the lighting module 1 is disposed on an opposite end of the heat-dissipating portion 40. A stabilizer (not shown) is disposed inside the mounting portion 41 and connected electrically to the lighting module 1. The base plate 10 is disposed on one end of the main body 4.

Specifically, the mounting portion 41 of the main body 4 is substantially a column-like structure. The heat-dissipating portion 40 includes a plurality of heat-dissipating fins 400, which is arranged annularly on the main body 4. A venting space 410 is formed between adjacent heat-dissipating fins 400 for venting generated heat. The structural configuration of the main body 4 is not restricted.

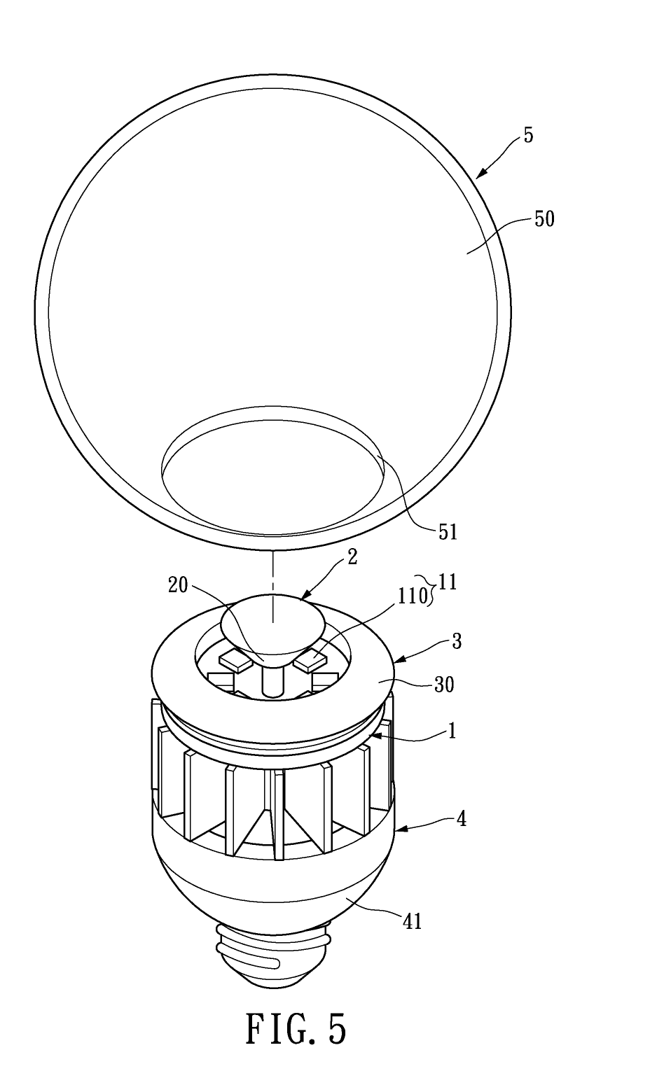

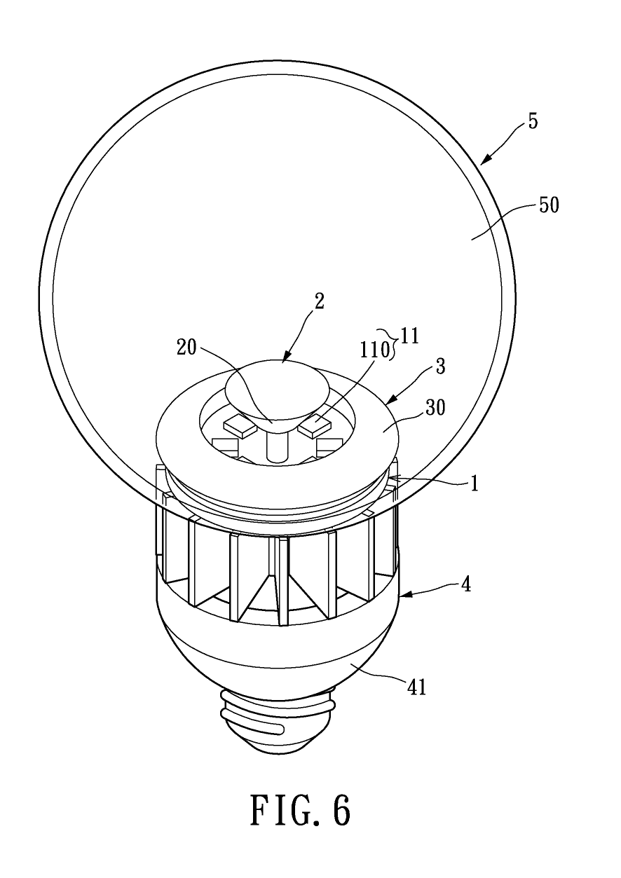

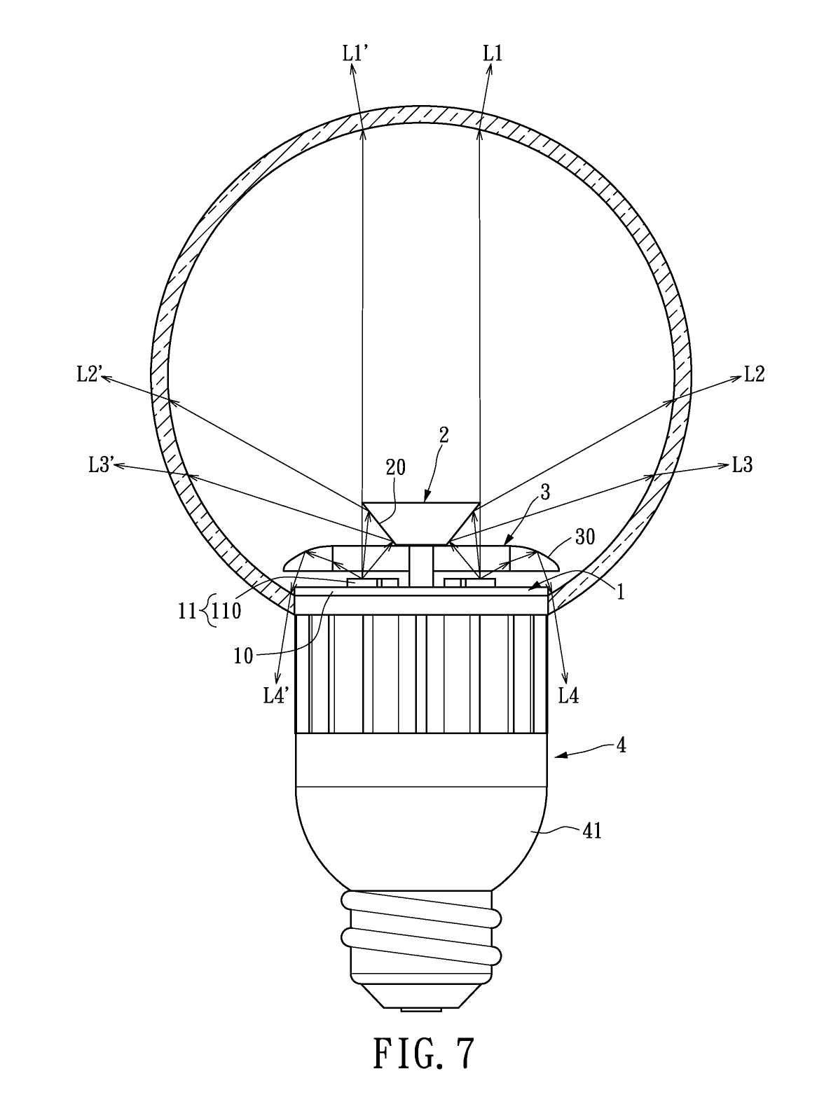

Please refer to FIGS. 5, 6, and 7. FIG. 5 is a schematic view showing a cover 5 and the lighting device of the instant disclosure. FIG. 6 is a perspective view showing the cover 5 mounted on the lighting device. FIG. 7 shows the light traveling paths for the cover-mounted lighting device.

In comparing to FIGS. 1˜4, FIGS. 5˜7 further show the cover 5. As shown in FIG. 5, the cover 5 is a hollow and spherical-shaped structure. The cover 5 is constructed of light-permitting material and defines a receiving space 50. The cover 5 is selectively mounted on the main body 4, where the lighting module 1, the reflector 2, and the light-guiding member 3 are arranged in the receiving space 50.

Furthermore, the cover 5 is formed with a mounting hole 51. The mounting hole 51 is shaped to engage matchingly to one end (i.e., the upper end) of the main body 4. When the cover 5 is mounted on the main body 4, the lighting device is used as a light bulb. When the cover 5 is not mounted on the main body 4, the lighting device is used as a projection or display light.

The cover 5 can be blended with light-adjusting particles (not shown). For example, the illumination range can be adjusted through the light-adjusting particles, as the light emits from the LEDs 110 and through the cover 5. However, the type of the cover 5 is not restricted.

Furthermore, the light rays L1, L1′, L4, and L4′ emitted from the LEDs 110 generate an omni-directional lighting effect. Such performance differs significantly from conventional energy-saving light bulbs. The reflector 2 and the light-guiding member 3 are not electrically operated, thus require no additional power. In addition, the shape of the reflective surface 20 and the polarizing portion 30 can be adjusted depending on application to obtain desired lighting effect.

The lighting device of the instant disclosure has the following advantages. First, by utilizing the reflector and the light-guiding member, no additional LEDs are needed to enhance the illumination quality. The operating efficiency of the lighting device is increased. The use of polarizing portion adjusts the light traveling path to provide omni-directional lighting effect and minimize shadow effect associated with conventional lighting. The shape of the reflector and the light-guiding member can be adjusted depending on application to provide desired illumination effects. Moreover, the cover is optionally mounted on the main body, such that the lighting device can be used as a display light or a light bulb.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A lighting device, comprising:
a lighting module having a base plate supporting a plurality of annularly arranged light-emitting units;
a reflector having at least one reflective surface in proximate to one side of the base plate, the cross-section area of the reflector gradually decreasing in a direction toward the base plate;
a light-guiding member disposed between the lighting module and the reflector, the light guiding member having a polarizing portion for reflecting light emitted from the light-emitting units; and
a main body supporting the base plate.

2. The lighting device according to claim 1, further comprising a cover selectively mounted on the main body, wherein the cover has a receiving space to accommodate the lighting module, the reflector, and the light-guiding member.

3. The lighting device according to claim 1, wherein the reflector is cone-shaped and non-light permitting.

4. The lighting device according to claim 3, wherein the reflective surface of the reflector is arch-shaped for reflecting light emitted by the light-emitting units.

5. The lighting device according to claim 1, wherein the light-guiding member is light-permitting and annular shaped, and wherein the light-emitting units are disposed within the area that the light-guiding member orthographically project on one side of the base plate.

6. The lighting device according to claim 5, wherein the polarizing portion is substantially arch-shaped and having a polished surface texture, wherein the inner diameter of the polarizing portion gradually decreases in a direction away from the base plate, and wherein the polarizing portion reflects light emitted from the light-emitting units.

7. The lighting device according to claim 1, wherein the reflector is substantially pyramid-shaped, and wherein the reflective surfaces of the reflector are held facing toward the light emitting direction of the light-emitting units.

8. The lighting device according to claim 4, wherein the reflective surface is selected from a group consisting of a flat surface, a parabolic surface, a free-form surface, and a polysurface.

9. The lighting device according to claim 1, wherein the lighting module is disposed on the main body, and wherein the main body has a heat-dissipating portion and a mounting portion connected therewith.

10. The lighting device according to claim 1, wherein the base plate includes a circuit board, and wherein the light-emitting units are light emitting diodes connected electrically to the circuit board.
